(19) United States
(12) Patent Application Publication
(10) Pub. No.: US 2010/0284135 A1
(43) Pub. Date: Nov. 11, 2010

(54) WEARABLE ELECTRONIC APPARATUS

(75) Inventors: Giampietro Tecchiolli, Trento (IT); Giorgio Pezzulli, Udine (IT); Stefano Adami, Volano (IT)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: EUROTECH SPA, Amaro (UD) (IT)

(21) Appl. No.: 12/669,192

(22) PCT Filed: Jul. 14, 2008
(86) PCT No.: PCT/EP2008/059197

§ 371 Date: Mar. 1, 2010

(30) Foreign Application Priority Data
Jul. 16, 2007 (IT) UD2007A000127

(51) Int. Cl. G06F 1/16

(52) U.S. Cl. 361/679.03

(57) ABSTRACT

A wearable electronic apparatus including a plurality of electronic units, each of which emits, with different intensities, specific luminous, acoustic and/or electromagnetic waves or signals, for the functioning thereof. The electronic apparatus includes a control member suitable to regulate or de-activate in a coordinated manner the intensity of emission of the individual electronic units according to or pre-definable emission thresholds of each electronic unit. The thresholds are correlated to environments and or operating conditions that are pre-defined, pre-definable, or defined on each occasion.

### FIELD OF THE INVENTION

The present invention concerns an electronic apparatus, wearable advantageously but not only on the wrist, provided with an automatic control member of the electromagnetic, luminous, acoustic or other emissions of the electronic apparatus, according to specific emission thresholds, correlated to specific environments and/or operating conditions in which the wearable electronic apparatus is used.

### BACKGROUND OF THE INVENTION

Wearable electronic apparatuses are known, such as for example wrist processors, known as wearable computers, Personal Assistants (PA), Personal Enhancement (PE), intelligent visors for night vision or others, which assist the user in performing a plurality of operations, or which provide the user with an increase in his own perceptive or active capacities.

This type of wearable electronic apparatus, due to the normal functional requirements of transportability, must be of limited size, limited weight and must comprise electronic units to interface with multimedia and telecommunication digital technologies such as for example: rear-lit display interfaces with touchscreen input technology interface; command/input keys, wireless communication systems and information exchange; and others.

It is also known that in certain sensitive operating environments, such as for example chemical or scientific laboratories, military areas or other, it is necessary to keep below certain minimum thresholds the emission values of luminous, acoustic and electromagnetic waves generated, voluntarily or not, by the individual electronic units that make up the wearable electronic apparatus during their normal use, in order to prevent possible disturbances or interferences with the instruments present in the environment.

In other applications, (for example military), the reduction of the emissions to within specific thresholds allows the operator not to be identified by a hostile presence detecting the emissions generated by the apparatus.

Electronic apparatuses wearable on the wrist are also known that are provided with individual and specific management apparatuses that regulate autonomously and selectively the different levels of emission of a relative electronic unit, for example in order to limit or temporarily eliminate the luminous, acoustic or electromagnetic waves.

The apparatuses that manage known wearable electronic apparatuses act in individual mode, however, only on the relative electronic unit, for example only to switch off the display, or only to interrupt the wireless transmissions, thus considerably reducing the overall functional efficiency of the wearable electronic apparatus.

Furthermore, known management apparatuses act on the individual electronic units only as a function of a particular command, or timed programming, without any reference to possible disturbance limits.

Another disadvantage is that management apparatuses, intervening separately only on the relative electronic units, have difficulties in reciprocal coordination, so as to entail an overall reduction in the emissions, which is not always optimum and effective, especially in operating conditions where some emissions are allowed, others limited and others completely dis-enabled.

Furthermore, the regulations of intensity of the various electronic units have to be made by acting individually on the different apparatuses; this requires, on each occasion, long and complex programming operations which, in some environmental or operating conditions, can be difficult, dangerous or require the intervention of specialized personnel.

Moreover, in manual configuration it is often not immediately possible to select an alternative interface (or a combination of user interfaces) suitable for the environment used.

Purpose of the present invention is to achieve an electronic apparatus wearable on the wrist that can regulate, for example limit, or de-activate the individual emissions of luminous, sound and electromagnetic waves, according to certain minimum thresholds, in a coordinated and optimized manner, simply and quickly, and substantially without compromising the correct functioning of the electronic apparatus itself.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a wearable electronic apparatus according to the present invention comprises a plurality of electronic units, each one able to emit, in commanded mode or by collateral functioning effect and with different specific intensities, luminous, sound and/or electromagnetic waves or signals, during its functioning.

According to a variant, the electronic units comprise at least an interface unit, such as a monitor, an audio unit, a transceiver unit or suchlike, and an electronic calculation card, such as a CPU or other which allows to process a plurality of data and to manage the functions of the interface unit.

According to a characteristic feature of the present invention, the electronic apparatus comprises a control member suitable to regulate, for example to limit or de-activate in a coordinated manner, and according to predefined and/or predefinable emission thresholds of each electronic unit, the intensity of emission of the individual electronic units. Said thresholds are correlated to environments and/or operating conditions that are pre-defined, pre-definable or defined on each occasion, for example according to a specific signal arriving from outside.

In this way, the intensity of emission of every individual electronic unit is regulated coordinately by the control member, according to the environment and/or operating condition in which it is, and the specific emission thresholds provided for each environment and/or operating condition. It is thus possible, for example, to limit only some of the emissions that in the specific environment create a disturbance, to keep others unchanged, to select alternative electronic units compatible with the operating environment.

In this way, it is possible to guarantee in any case the full functional efficiency of the electronic apparatus, that is, it is possible to use the electronic apparatus effectively even when carrying out limitations and restrictions to the electronic units. For example, in the case of limiting the emission of some primary functions, such as the display, in order to limit as much as possible the luminous diffusion of the apparatus, for example in a dangerous environment, the present invention provides to use alternative units, such as loudspeakers with a low threshold, vibrations or other, so as to render the electronic apparatus in any case usable with the same functions but without exceeding a pre-defined threshold of maximum allowed emission.

With the present invention, according to a variant, it is also possible to provide compensation in the functioning of electronic units that emit coherent signals, keeping them inside the same limit threshold. This solution thus allows to increase the functioning intensity of some functions, for example data reception, compared with other functions, for example calculation, which emit waves or signals substantially in the same range of frequencies.

Furthermore, by providing a control member, we also obtain a reduction in the times necessary for the programming operations, with the possibility of setting different functioning thresholds, according to the different environmental and/or operating conditions in which the apparatus is to operate; it is also possible to provide to send from outside, for example by means of a radio signal, the limit values of the specific emission thresholds which must be respected by the different electronic units, according to the real environmental and/or operating conditions.

In this way, it is not necessary to effect a priori the programming of the control member, nor is the intervention required of specialized personnel directly on the apparatus.

In one form of embodiment of the present invention, the wearable electronic apparatus comprises at least a selector means, connected to the control member, and able to be activated manually by the user in order to select different emission intensities of the individual electronic units of the electronic apparatus, according to thresholds defined with respect to the environment and/or the operating conditions.

In one form of embodiment of the present invention, the wearable electronic apparatus also comprises sensor means connected to the control member and able to detect different environments and/or operating conditions in terms of the requirements of sensitivity to disturbances, for example operating rooms, laboratories or other, so as to command the control member in order to regulate or to consequently de-activate the intensity of emission of the individual electronic units of the electronic apparatus.

According to another form of embodiment of the present invention, the electronic apparatus comprises at least an electronic memory, in which a plurality of data is able to be memorized, so that at least at the moment when one or another of the electronic units of the apparatus is functionally limited or de-activated by the control member, data can in any case be detected which will be retrieved and interpreted by the user later.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic view of a wearable electronic apparatus according to the present invention;

FIG. 2 shows an enlarged detail of the electronic apparatus in FIG. 1, in a first operating mode;

FIG. 3 shows an enlarged detail of the electronic apparatus in FIG. 1, in a second operating mode.

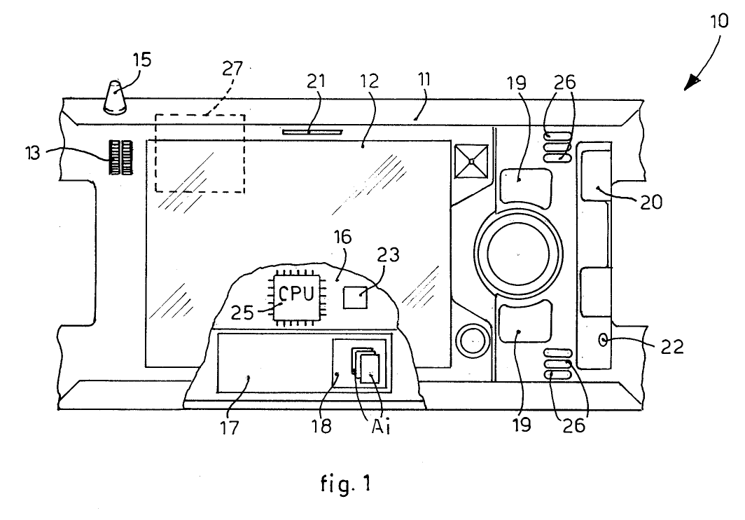

### DETAILED DESCRIPTION OF A PREFERENTIAL FORM OF EMBODIMENT

With reference to the attached drawings, an electronic apparatus 10 according to the present invention in this case is of the type that can be worn on the user's wrist, and known as wearable computer, that is, with functions as Personal Assistant (PA) or Personal Enhancement (PE). It functions as an assistant to the user in performing a number of operations, such as for example detecting particular maintenance or functioning parameters of a machine, or in providing the user with an increase in his perceptive or active capacities, for example to improve night vision, or to protect the eyes from very intense lights, or other.

The electronic apparatus 10 according to the present invention comprises an external containing casing 11, a display unit 12, an audio unit 13, a transceiver unit 15, an electronic data processing card 16, and a control member 17 connected to the display unit 12, to the audio unit 13, to the transceiver unit 15 and to the electronic card 16, to coordinate and command their different functioning modes and their modes of emitting luminous, sound, electromagnetic or other waves or signals, according to individual emission thresholds for each unit 12, 13, 15 and 16; the thresholds are programmed and/or programmable according to environmental and/or operating conditions that are pre-defined, pre-definable or defined on each occasion.

In this way it is possible to define a plurality of environmental and/or operating conditions in each of which different emission threshold levels are set for all the units 12, 13, 15, 16 and others, provided in the apparatus. We therefore have: Aᵢ=ƒᵢ(S₁, S₂, S₃, . . . , Sₙ) where Aᵢ is a generic environment and/or operating condition and S₁, S₂, S₃, . . . Sₙ are the different emission thresholds provided for each unit 12, 13, 15, 16 of the electronic apparatus 10. It is clear that each unit 12 to 16 may have one or more thresholds corresponding to a different signal emitted. For example, a warning alarm may have both a luminous and an acoustic emission, each having its specific threshold. In other cases, a unit may emit both an electromagnetic radiation and a luminous signal.

Each function ƒᵢ, provides a link or connection between the thresholds of all the units 12 to 16 of the apparatus 10, in such a way that the thresholds Sᵢ, . . . Sₙ are not considered individually with respect to the defined environment Aᵢ but are considered as a whole, in order not only to maintain the total emission of a specific type below a pre-defined threshold, but also to select an alternative if the emission of a specific unit must be limited to a value that it cannot perform its function in an effective way for the user.

The different operating environments and/or conditions A, are advantageously memorized inside a memory 18 provided inside the control member 17.

The external casing 11 in this case comprises a plurality of selection and command keys, possibly lit from the rear, to allow easy display in poor lighting conditions, and a selection bar 20 connected to the control member 17 and mounted sliding so as to be selectively disposed between two or more positions, each defining a predetermined functioning mode, according to which the control unit 17 associates corresponding emissions for each unit 12, 13, 15, 16 of the electronic apparatus 10.

On the external casing 11 there are also some LED 26 which indicate different functioning and emission states of the electronic apparatus 10 and/or generate visual warning signals.

Both the keys 19 and the LED 26 determine a luminous emission due respectively to the intensity of their rear lighting and the intensity of their ignition.

According to a variant, shown schematically with a line of dashes, a plurality of sensors 21 are also provided in the device, able to detect different parameters of the environment and/or position where the electronic apparatus 10 is to be found. The sensors 21 are connected to the control member 17 to condition the functioning and emission mode of the various components 12, 13, 15 and 16, according to the environmental and/or operating conditions detected where the electronic apparatus 10 is to be found.

The display unit 12 allows to display data and in this case comprises a rear-lit LCD monitor, mounted outside the casing 11, and provided on the surface with a touchscreen film, for interaction with the user.

The display unit 12 determines a luminous emission due to the intensity of the rear lighting of the LCD monitor, and also an electromagnetic emission deriving from the relative pilot electronics.

In association with, or as an alternative to, the LCD monitor, the display unit 12 can be provided with a remote vision system in direct correspondence with the user's view point, such as for example a helmet with a monitor integrated into the visor.

The audio unit 13 comprises at least a loud speaker, of a substantially known type and not shown in detail here, facing towards the outside of the external casing 11 and able to broadcast acoustic signals or instructions that the user can perceive.

The audio unit 13 determines an acoustic emission due to the acoustic broadcasts emitted by its loud speaker.

The audio unit 13 also comprises a connection socket 22 for an earphone. According to the sensitivity of the operating environment it is possible to use an earphone in wired or wireless connection with the electronic apparatus 10.

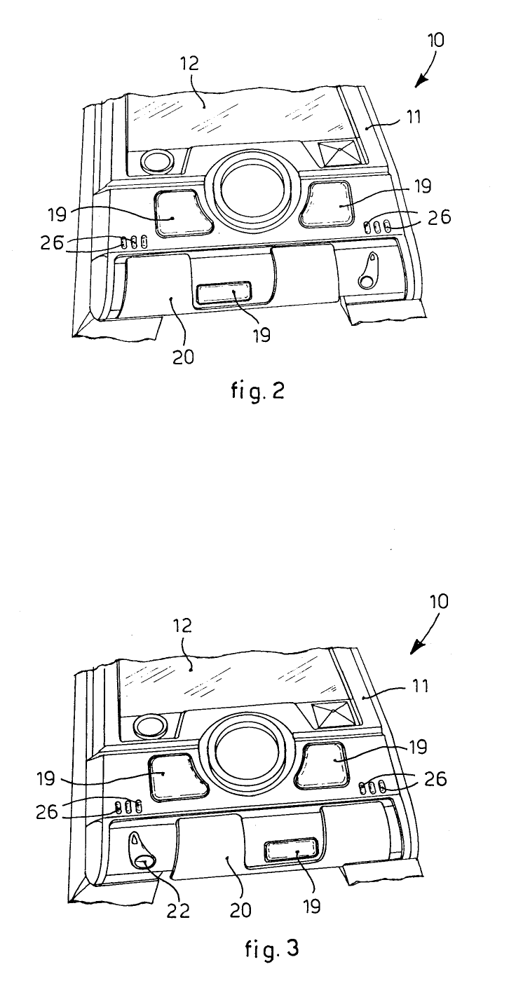

In particular, the socket 22 is disposed in a position such as to be selectively covered by the selection bar 20, when the electronic apparatus 10 is made to function in a mode where said socket 22 is not necessary (FIGS. 2 and 3).

According to a variant, the audio unit 13 comprises a vibration unit 27 able to stimulate the user with a slight vibration, especially, but not only, in a functioning mode with a reduced emission of the electronic apparatus 10.

The transceiver unit 15 is of the wireless type, for example using Bluetooth® technology, for the reception/transmission from and to external users of the electronic apparatus 10. The transceiver unit 15 also comprises in this case an electronic memory 23 able to store data both output from and input in the electronic apparatus 10, so that said data can be made available to the user at later times after their actual reception or transmission. The transceiver unit 15 is able to receive command signals from a remote command station, so as to be able to set from the outside different functioning and emission modes of the units 12, 13, and 16 of the electronic apparatus 10.

The electronic card 16 comprises a calculation microprocessor 25 able to process a plurality of data, either inserted by the user or detected by the sensors 21, or pre-set, to define the logical functioning of the electronic apparatus 10.

Both the transceiver unit 15 and the electronic card 16 mainly generate an electromagnetic disturbance, even very intense, during their active functioning. This disturbance, in the case of the transceiver unit 15, is a signal voluntarily emanated, while in the case of the electronic card 16 it is an unwanted collateral effect. The control member 17 is able to modulate individually and in a coordinated manner the levels of electromagnetic emission of the transceiver unit 15 and the electronic card 16. In this way it is possible to keep the overall electromagnetic emission of the electronic apparatus 10 below a determinate emission level, set according to the specific environmental and/or operating conditions.

The electronic apparatus 10 according to the present invention functions as follows.

The control member 17 understands, substantially constantly, the data detected by the sensors 21 and/or the command signals received from the transceiver unit 15 and/or the data concerning the position of the selection bar 20 and/or the functioning logic commanded by the calculation microprocessor 25 of the electronic card 16 and, according to the different conditions and/or operating environments programmed, programmable and/or defined on each occasion of the environment and/or operating condition, determines the need to limit under the specific thresholds the specific values of luminous and/or acoustic and/or electromagnetic emission of the individual units 12, 13, 15 and 16 of the electronic apparatus 10.

For example, the control member 17 can command the passage from one functioning mode of the electronic apparatus 10 to another, by the manual activation of the selection bar 20, or by the transmission of a command signal from a remote station, or by the prior programming of the environmental operating characteristics.

According to a variant, the control member 17 is provided with an automatic identification support for access to a determinate sensitive area, using for example a radio identification system, for example of the TAG type, with RFID technology. In this way, the control member 17 identifies the passage of the electronic apparatus 10 through the access to a sensitive area identified by a univocal TAG, automatically coordinating the regulation of the individual emission levels of the units 12, 13, 15 and 16, keeping them below specific and determinate limit threshold emissions, specific for said operating environment.

In another form of preferential embodiment, the control member 17 is programmed so as to be commanded off-line, to set different threshold levels for the intensity of the emissions generated according to the specific use and to environmental sensitivity.

According to a variant, the control member 17 is programmed on-line by a remote device. In this case a radio signal identifying the environment provides the definition of the relative thresholds.

The control member 17 then intervenes in a coordinated manner, on the display unit 15 and/or the audio unit 13 and/or the transceiver unit 15 and/or the electronic card 16, to reduce individually the intensities of emission in different operating modes, according to the specific environmental situations that are detected and/or set, substantially as shown in the following table.

| Emission | | | Alternative electronic |
|---|---|---|---|
| involved | Intervention | Function variation | unit/countermeasure |
| Luminous, | Switches off rear-lighting | Visibility of LCD | Vibration unit 27 (In case |
| electromagnetic | of display unit 12 | monitor in luminous | of simple graphic interface |
| | | environment reduced or | with low information |
| | | annulled; visibility of | content); possible helmet |
| | | LCD monitor in dark | with integrated monitor |
| | | annulled; input from | |
| | | touchscreen film | |
| | | annulled | |
| Luminous, | Switches off rear-lighting | Impossible to visually | Characteristic disposition |
| electromagnetic | of keys 19 | identify the keys in dark | of individual keys 19 |
| Luminous, | Switches off LED 26 | Impossible to obtain | Audio unit 13; vibration |
| electromagnetic | | luminous information on | unit 27 |
| | | system state | |
| Electromagnetic | Switches off display | Visibility of LCD | Vibration unit 27 (In case |
| | completely | monitor annulled; input | of simple graphic interface |
| | | with touchscreen film | with low information |
| | | annulled | content); possible helmet |
| | | | with integrated monitor |
| Acoustic | Reproduction of audio unit | Direct audio output from | Audio output from socket |
| | 13 dis-enabled | loudspeaker impossible | 22; vibration unit 27 (for |
| | | | example impulse type, in |
| | | | case of reproduction of |
| | | | warning signals) |
| Electromagnetic | Reduction/suspension of | Computing power of | |
| | frequency of main clock | electronic card 16 and/or | |
| | sources of the electronic | functions of other | |
| | card 16 | interface units (12, 13, | |
| | | 15) reduced | |
| Electromagnetic | Limitation of switching | Possible limitation of | |
| | speed of the fast digital | computing power of | |
| | signals by electronic card | electronic card 16 and | |
| | 16 | communication speed of | |
| | | the transceiver unit 15 | |
| Electromagnetic | Clock signals with low | Possible limitation of | |
| | electromagnetic noise | computing power of | |
| | (peak) of the electronic | electronic card 16 and | |
| | card 16 generated | communication speed of | |
| | | transceiver unit 15 | |
| Electromagnetic | Transceiver unit 15 | Impossible to use | Data stored on electronic |
| | switched off | standard wireless | memory 23; radio |
| | | transmission | communications that |
| | | | respect Ultra Wide Band |
| | | | specifications |
| Electromagnetic | Transceiver unit 15 with | Wireless transmission | |
| | no-reply wireless protocol | impossible | |
| Electromagnetic | Transceiver unit 15 using | | |
| | wireless connection | | |
| | techniques with very low | | |
| | spectral density of power | | |
| | transmitted | | |
| Electromagnetic | Transceiver unit 15 con | Distance and/or speed of | Electronic memory 23; |
| | wireless communication | communication of the | radio communications that |
| | with management of | transceiver unit 15 | respect Ultra Wide Band |
| | transmission power, | reduced | specifications |
| | connection quality | | |
| Electromagnetic | Transceiver unit 15 with | Communication distance | Electronic memory 23; |
| | use of short-range wireless | reduced to less than a | radio communications that |
| | communication interfaces | meter from the | respect Ultra Wide Band |
| | | transceiver unit 15 | specifications |

It is clear, however, that modifications and/or additions of parts may be made to the electronic apparatus 10 as described heretofore, without departing from the field and scope of the present invention.

It is also clear that, although the present invention has been described with reference to specific examples, a person of skill in the art shall certainly be able to achieve many other equivalent forms of wearable electronic apparatus, having the characteristics as set forth in the claims and hence all coming within the field of protection defined thereby.

1-11. (canceled)

11. A wearable electronic apparatus comprising a plurality of electronic units comprising at least a display unit, an audio unit, a transceiver unit and an electronic calculation unit, each able to emit, with different adjustable intensities, specific luminous, acoustic and/or electromagnetic waves or signals for the functioning thereof, the apparatus further comprising a plurality of sensors for detecting different parameters of an environment and/or position where said electronic apparatus is to be found, the apparatus further comprising a control member suitable to regulate or de-activate in a coordinated manner the intensity of emission of said individual electronic units according to pre-defined or pre-definable emission thresholds of each of said electronic units, said thresholds being correlated to environments and or operating conditions pre-defined or detected by said sensors so that the total emission of a specific type is maintained below a pre-defined threshold of maximum allowed emission for the whole of the electronic units, or an alternative electronic unit is selected if the luminous, acoustic and electromagnetic emission of a specific unit must be limited to a value that the specific unit cannot perform the function thereof in an effective way for the user.

12. The wearable electronic apparatus as in claim 11, wherein said control member comprises at least a memory in which at least some environments and/or operating conditions are saved with the relative emission thresholds of the individual electronic units.

13. The wearable electronic apparatus as in claim 11, comprising at least a selector means, connected to said control member, and able to be moved manually in order to select different intensities of emission of each of said electronic units, according to specific emission thresholds.

14. The wearable electronic apparatus as in claim 13, wherein the movement of said selector means selectively prevents or allows the possibility of using connections and/or other accessory units, according to the specific intensity of emission selected.

15. The wearable electronic apparatus as in claim 11, comprising at least an electronic memory, in which a plurality of data are able to be memorized.

16. The wearable electronic apparatus as in claim 11, comprising one or more luminous signalers able to signal visually the functioning mode of the system or of the individual electronic units.

17. The wearable electronic apparatus as in claim 11, comprising an external casing in which said electronic units are mounted.
